(19) United States
(12) Patent Application Publication
(10) Pub. No.: US 2018/0167857 A1
(43) Pub. Date: Jun. 14, 2018

(54) HANDOVER METHOD, SYSTEM AND USER EQUIPMENT

(71) Applicant: Industrial Technology Research Institute, Hsinchu (TW)

(72) Inventors: Tzi-Cker CHIUEH, Taipei City (TW); Ching-Yao WANG, Hsinchu County (TW); Yu-Chi LU, Taoyuan City (TW)

(21) Appl. No.: 15/619,409

(22) Filed: Jun. 9, 2017

(30) Foreign Application Priority Data
Dec. 8, 2016 (TW) 105140595

(51) Int. Cl. H04W 36/14; H04W 36/30; H04L 12/26

(52) U.S. Cl. CPC H04W 36/14; H04W 88/02; H04L 43/16; H04W 36/30

(57) ABSTRACT

A handover method, system and user equipment are provided. The handover method includes establishing a voice call between a caller device and a callee device in a first network; detecting first-link performance between the caller device and the first network and detecting second-link performance between the caller device and a second network; detecting third-link performance between the callee device and the second network; and determining whether to turn over from the first network to the second network and start a standby call between the caller device and the callee device which has been established in the second network, according to the first-link performance, the second-link performance and the third-link performance, wherein the first network and the second network are respectively a circuit-switched network and a packet-switched network or respectively a packet-switched network and a circuit-switched network.

### CROSS REFERENCE TO RELATED APPLICATIONS

This Application claims priority of Taiwan Patent Application No. 105140595, filed on Dec. 8, 2016, the entirety of which is incorporated by reference herein.

### TECHNICAL FIELD

The disclosure generally relates to a handover controlling technology for a voice call, and which performs a handover between a circuit-switched network (CS-network) and a packet-switched network (PS-network) of a voice call through a wireless network.

### BACKGROUND

With growing demand for mobile communications, the Global System for Mobile communications (GSM) supporting only circuit-switched (CS) domain services may no longer meet user requirements. Accordingly, the mobile communications working groups and standard groups have developed the so-called third-generation mobile communications technologies, such as Wideband Code Division Multiple Access (W-CDMA), Code Division Multiple Access-2000 (CDMA-2000), Time Division-Synchronous Code Division Multiple Access (TD-SCDMA), etc. In the Universal Mobile Telecommunications System (UMTS) using W-CDMA technology, for example, the 3rd Generation Partnership Project (3GPP) has further proposed the Long Term Evolution (LTE) system, and called for the fourth-generation mobile (4G) communications system to be implemented to meet future demand for large wireless data-transmission bandwidths. The LTE system aims to provide an all-IP architecture, in which only a packet-switched (PS) domain, instead of a CS domain, is used to carry all mobile communications services. For example, the voice service provided by the CS domain is changed to be provided through Voice over Internet Protocol (VoIP) technology in the fourth-generation mobile communications system.

However, during transition from 2G and 3G mobile communications systems to a 4G mobile communications system, some operators have still chosen to provide voice services via the CS domain of the 2G and 3G mobile communications systems, due to the coverage rate and capacity of the CS domain of the 2G and 3G mobile communications system already being sufficient. This raises a problem wherein the architecture of the 2G and 3G mobile communications systems include both the CS domain and PS domain, while the 4G mobile communications system includes only the PS domain. Accordingly, the interconnections between the 2G and 3G mobile communications systems and the 4G mobile communications system, especially the CS domain part, must be defined and specified, so that systems using different standards can achieve smooth interoperability when providing voice services to users. One technique used is Circuit Switched Fallback (CSFB) architecture, which is defined in the 3GPP TS 23.272 specification.

With mobile communication technology, a user may process a voice call anywhere through the telecommunication network (i.e. CS network), but when the user moves inside (e.g. a basement) or to certain other locations where reception is bad, call performance may suffer, or calls may be dropped due to the bad signals between the user equipment (US) and the telecommunication network.

### SUMMARY

A handover method, system and user equipment are provided.

An embodiment in accordance with the disclosure provides a handover method. The handover method includes establishing a voice call between a caller device and a callee device in a first network; detecting first-link performance between the caller device and the first network and detecting second-link performance between the caller device and a second network; detecting third-link performance between the callee device and the second network; and determining whether to turn over from the first network to the second network and start a standby call between the caller device and the callee device which has been established in the second network, according to the first-link performance, the second-link performance and the third-link performance, wherein the first network and the second network are respectively a circuit-switched network and a packet-switched network or respectively a packet-switched network and a circuit-switched network.

An embodiment in accordance with the disclosure provides user equipment applied as a caller device. The user equipment at least includes a radio communication device and a call processing device. The radio communication device establishes a voice call with a callee device through a first network. The call processing device detects first-link performance between the caller device and the first network and detects second-link performance between the caller device and a second network. The call processing device further determines whether to turn over from the first network to the second network and start a standby call between the caller device and the callee device which has been established in the second network, according to the first-link performance and the second-link performance, wherein the first network and the second network are respectively a circuit-switched network and a packet-switched network or respectively a packet-switched network and a circuit-switched network.

An embodiment in accordance with the disclosure provides user equipment applied as a callee device. The user equipment at least includes a radio communication device and a call processing device. The radio communication device establishes a voice call with a caller device through a first network. The call processing device detects third-link performance between the callee device and a second network, and according to the third-link performance determines whether to accept a standby call invitation from the caller device. When a handover from the first network to the second network is performed, the call processing device starts a standby call with the caller device which has been established in the second network, wherein the first network and the second network are respectively a circuit-switched network and a packet-switched network or respectively a packet-switched network and a circuit-switched network.

An embodiment in accordance with the disclosure provides a handover system. The handover system includes a first network, a second network, a callee device and a caller device. The callee device detects third-link performance between the callee device and the second network. The caller device establishes a voice call between the caller device and the callee device in a first network, and detects first-link performance between the caller device and the first network and detecting second-link performance between the caller device and a second network. According to the first-link performance, the second-link performance and the third-link performance, the caller device further determines whether to turn over from the first network to the second network and start a standby call between the caller device and the callee device which has been established in the second network, wherein the first network and the second network are respectively a circuit-switched network and a packet-switched network or respectively a packet-switched network and a circuit-switched network.

The foregoing will become better understood from a careful reading of a detailed description provided herein below with appropriate reference to the accompanying drawings.

### BRIEF DESCRIPTION OF THE DRAWINGS

The disclosure will become more fully understood by referring to the following detailed description with reference to the accompanying drawings, wherein:

FIG. 1 is a block diagram of a communications system 100 according to an embodiment of the disclosure;

FIG. 2 is a block diagram of the caller device 110 according to an embodiment of the disclosure;

FIG. 3 is a schematic diagram of the first network 120 according to an embodiment of the disclosure;

FIG. 4A-4B is a flowchart 400 illustrating a caller device handing over from the CS network to the PS network according to an embodiment of the disclosure;

FIG. 5 is a flowchart 500 illustrating a callee device handing over from the CS network to the PS network according to an embodiment of the disclosure;

FIG. 6A-6B is a flowchart 600 illustrating a caller device handing over from the PS network to the CS network according to an embodiment of the disclosure;

FIG. 7 is a flowchart 700 illustrating a callee device handing over from the PS network to the CS network according to an embodiment of the disclosure.

### DESCRIPTION OF THE EMBODIMENTS

The descriptions of the disclosure are some embodiments for the purpose of illustrating the general principles of the disclosure and should not be configured to limit the disclosure. The scope of the invention is determined by reference to the appended claims.

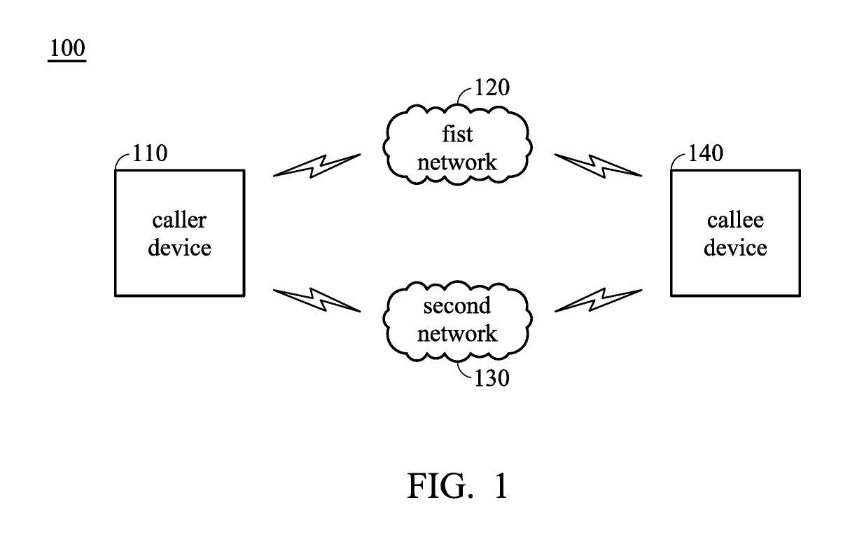

FIG. 1 is a block diagram of a communications system 100 according to an embodiment of the disclosure. As shown in FIG. 1, the communications system 100 includes a caller device (originating device) 110, a first network 120, a second network 130 and a callee device (terminating device) 140. FIG. 1 presents a simplified block diagram in which only the elements relevant to the disclosure are shown. However, the disclosure is not limited to what is shown in FIG. 1.

In an embodiment, the caller device 110 and the callee device 140 may be user equipment which supports the voice call function, such as a cellular phone, a mobile phone, a mobile phone, a data card, a laptop stick, a mobile hotspot, a USB modem, or a tablet, but the disclosure is not limited to these.

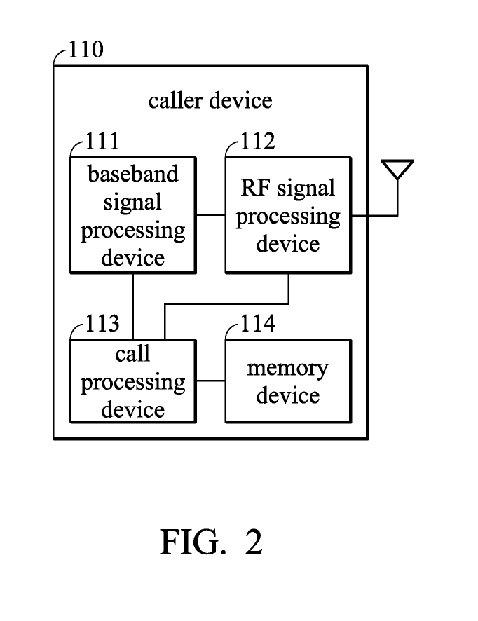

FIG. 2 is a block diagram of the caller device 110 according to an embodiment of the disclosure. As shown in FIG. 2, the caller device 110 may include at least a baseband signal processing device 111, a radio frequency (RF) signal processing device 112, a call processing device 113, a memory device 114, and an antenna module comprising at least one antenna. The call processing device 113 may include at least one processor which is configured to execute the instructions stored in the memory device. Note that, in order to clarify the concept of the disclosure, FIG. 2 presents a simplified block diagram in which only the elements relevant to the disclosure are shown. However, the disclosure is not limited to what is shown in FIG. 2. In addition, the structure of the caller device 110 also could be applicable to the callee device 140. Therefore, the structure of the callee device 140 will not be illustrated further below.

In an embodiment of the disclosure, the RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may include a plurality of hardware elements configured to perform radio frequency conversion. For example, the RF signal processing device 112 may include a power amplifier, a mixer, etc.

The baseband signal processing device 111 may further be configured to process the baseband signals to obtain information or data transmitted by the peer communications apparatus. The baseband signal processing device 111 may also include a plurality of hardware elements configured to perform baseband signal processing. The baseband signal processing may include analog-to-digital conversion (ADC)/digital-to-analog conversion (DAC), gain adjustment, modulation/demodulation, encoding/decoding, and so on.

The call processing device 113 may be configured to control the operations of the baseband signal processing device 111 and the RF signal processing device 112. According to an embodiment of the disclosure, the call processing device 113 may also include a processor which is configured to execute the program codes of the software modules of the corresponding baseband signal processing device 111 and/or the RF signal processing device 112. The program codes accompanied by specific data in a data structure may also be referred to as a processing logic unit or a stack instance when being executed. Therefore, the call processing device 113 may be regarded as being included of a plurality of processing logic units, each configured to execute one or more specific functions or tasks of the corresponding software modules.

In some embodiments of the disclosure, the call processing device 113 may include a handover controlling module, a signal controlling module and a call module. The handover controlling module may be configured to determine whether a standby call has been established according to the signal performance to perform the handover. The signal controlling module may be configured to detect the signal performance and transmit the detected result to the handover controlling module. The call module may include a circuit-switched (CS) call module and a packet-switched (PS) module. The handover controlling module is configured to control the call module to perform the call through the CS call module or the PS call module. In some embodiments of the disclosure, the handover controlling module, signal controlling module and the call module may be integrated in a chip. In some embodiments of the disclosure, the handover controlling module, signal controlling module and the call module may be realized through software.

The memory device 114 may be configured to store the software and firmware program codes, system data, user data, etc. of the caller device 110. The memory device 114 may be a volatile memory such as a Random Access Memory (RAM); a non-volatile memory such as a flash memory or Read-Only Memory (ROM); a hard disk; or any combination thereof, but the disclosure is not limited to these.

According to an embodiment of the disclosure, the RF signal processing device 112 and the baseband signal processing device 111 may collectively be regarded as a radio communication device which is configured to communicate with a wireless network to provide wireless communications services in compliance with a predetermined Radio Access Technology (RAT). In some embodiments of the disclosure, the caller device 110 may be extended further to include antennas and/or radio modules, and the disclosure is not limited to what is shown in FIG. 2.

In addition, in some embodiments of the disclosure, the call processing device 113 may be configured to replace the baseband signal processing device 111, or the caller device 110 may include another call processing device configured to replace the baseband signal processing device 111. Thus the disclosure is not limited to the architecture shown in FIG. 2.

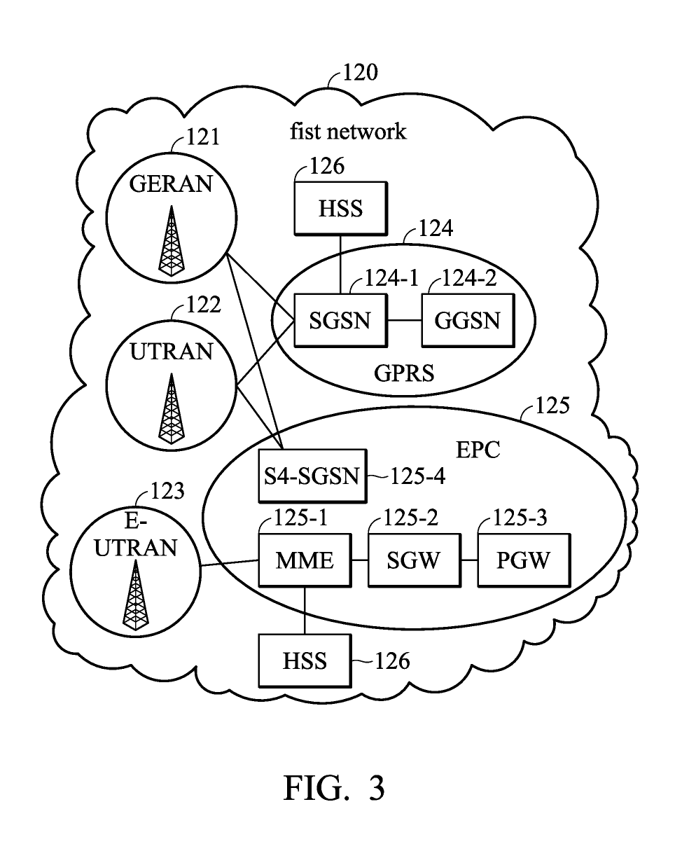

FIG. 3 is a schematic diagram of the first network 120 according to an embodiment of the disclosure. Note that, the structure of the first network 120 should not be limited to what is shown in FIG. 3.

As shown in FIG. 3, the first network 120 may be a telecommunication network. The first network 120 may include a GSM EDGE Radio Access Network (GERAN) 121, a Universal Terrestrial Radio Access Network (UTRAN) 122, an Evolved UTRAN (E-UTRAN) 123, a General Packet Radio Service (GPRS) subsystem 124 and an Evolved Packet Core (EPC) subsystem 125. The GERAN 121, UTRAN 122 and E-UTRAN 123 may be in communication with the GPRS subsystem 124 or the EPC subsystem 125, wherein the GERAN 121, UTRAN 122 and E-UTRAN 123 allow connectivity between the caller device 110 (and the callee device 140) and the GPRS subsystem 124 or the EPC subsystem 125 by providing wireless transmission and reception to and from the caller device 110 (and the callee device 140) for the GPRS subsystem 124 or the EPC subsystem 125. The GERAN 121, UTRAN 122 and E-UTRAN 123 may contain one or more base stations (also called NodeBs or eNodeBs) and Radio Network Controllers (RNCs). Specifically, the GPRS subsystem 124 includes a Serving GPRS (General Packet Radio Services) Support Node (SGSN) 124-1 and a Gateway GPRS Support Node (GGSN) 124-2, wherein the SGSN 124-1 is the key control node configured to control packet routing and transfer, mobility management (e.g., attach/detach and location management), session management, logical link management, and authentication and charging functions, etc., and the GGSN 124-2 is responsible for Packet Data Protocol (PDP) address assignments and interoperability with external networks. The EPC subsystem 125 may include a Mobility Management Entity (MME) 125-1, which is configured to be responsible for idle mode UE tracking, paging procedures, and attachment and activation processes. The EPC subsystem 125 may also include a Servicing Gateway (SGW) 125-2, which may be responsible for the routing and forwarding of data packets. The EPC subsystem 125 may also include a Packet data network Gateway (PGW) 125-3, which is configured to be responsible for providing connectivity from the caller device 110 to external networks. Both the SGSN 124-1 and the MME 125-1 may be in communication with Home Subscriber Server (HSS) 126 which may provide device identification information, an International Mobile Subscriber Identity (IMSI), etc. It should be appreciated that the EPC subsystem 125 may also include a S4-SGSN 125-4, thereby allowing the GERAN 121 or UTRAN 122 to be accessed when the GPRS subsystem 124 is replaced by the EPC subsystem 125. Additionally, the service network 120 may also include other functional entities, such as a Home Location Register (HLR) (not shown) which is a central database configured to store user-related and subscription-related information, and the disclosure is not limited thereto.

In some embodiments of the disclosure, the first network 120 may further include a Universal Mobile Telecommunications System (UMTS) network or a CDMA network.

In some embodiments of the disclosure, the caller device 110 and the callee device 140 perform a voice call through a circuit-switched (CS) network in a process that may be defined as the caller device 110 and the callee device 140 performing the voice call through the GERAN 121, UTRAN 122 or other 2G/3G networks (e.g. UMTS network and CDMA network) of the first network 120. In some embodiments of the disclosure, the caller device 110 and the callee device 140 perform the voice call through the CS network in a process may be defined as the caller device 110 performing the voice call with the callee device 140 through the Circuit Switched Fallback (CSFB) technology to fall back to the 2G/3G network from the E-UTRAN (LTE network or 4G network).

In some embodiments of the disclosure, the second network 130 may be a wireless network which is defined in the IEEE 802.11 standard, for instance Wi-Fi network. The caller device 110 and the callee device 140 may respectively connect to the second network 130 through a wireless access point. In some embodiments of the disclosure, the caller device 110 and the callee device 140 perform the voice call through a packet-switched (PS) network in a process that may be defined as the caller device 110 and the callee device 140 performing a voice or IP (VoIP) call through the second network 130 (e.g. Wi-Fi network). In the embodiments of the disclosure, the caller device 110 and the callee device 140 performing the voice call through the PS network may be regarded as an over-the-top (OTT) service being provided. In an embodiment of the disclosure, the caller device 110 and the callee device 140 may register to the VoIP service-end through the PS network in advance. When the caller device 110 and the callee device 140 have been registered to the VoIP service-end, the caller device 110 may obtain the register account and the line status of the callee device 140 from the VoIP service-end. For example, the caller device 110 may obtain the line status of the callee device 140 according to the session initiation protocol (SIP).

For convenience of illustrating the embodiments of the disclosure, the link performance between the caller device 110 and the CS network is defined as the first-link performance; the link performance between the caller device 110 and PS network is defined as the second-link performance; the link performance between the callee device 140 and PS network is defined as the third-link performance; and the link performance between the callee device 140 and the CS network is defined as the fourth-link performance. Note that the disclosure should not be limited to these definitions.

In addition, in the embodiments of the disclosure, the threshold T_{CH} and the threshold T_{CL} may respectively be defined as a high standard and a low standard of the link performances between the caller device 110 and the CS network and between the callee device 140 and the CS network. The threshold T_{PH} and the threshold T_{PL} may respectively be defined as a high standard and a low standard of the link performances between the caller device 110 and PS network and between the callee device 140 and PS network. The values of the thresholds T_{CH}, T_{CL}, T_{PH} and T_{PL} may be adjusted and set according to different requirements and situations.

In some embodiments of the disclosure, the caller device 110 and the callee device 140 detect the link performance between the caller device 110 and the CS or PS network and between the callee device 140 and the CS or PS network according to the signal strength. If the caller device 110 and the callee device 140 detect the link performance according to the signal strength, the thresholds T_{CH}, T_{CL}, T_{PH} and T_{PL} are regarded as the thresholds of different signal strengths. In some embodiments of the disclosure, the caller device 110 and the callee device 140 obtain the related information of the signal strength through an application built into the mobile phone. Using the Android system as an example, the caller device 110 and the callee device 140 may obtain the related information of the GSM signal strength through TelephoneyManager which is pre-defined in the Application Programming Interface (API) of the Android system and obtain the related information of the Wi-Fi signal strength through WifiManager which is pre-defined in the API of the Android system.

In other embodiments of the disclosure, the caller device 110 and the callee device 140 detect the link performance between the caller device 110 and the CS or PS network and between the callee device 140 and the CS or PS network according to other parameters or indicators, such as packet error rate, packet, bit error rate, frame error rate or signal to noise ratio (SNR). It should be understood that the disclosure is not limited thereto.

In an embodiment of the disclosure, when the caller device 110 and the callee device 140 initiate a voice call through a CS network, the caller device 110 may start to detect first-link performance between the caller device 110 and the CS network. In an embodiment of the disclosure, when the caller device 110 starts to detect first-link performance between the caller device 110 and the CS network, the caller device 110 may determine whether the first-link performance is lower than the threshold T_{CH}. If the first-link performance is higher than the threshold T_{CH}, it means that the link performance between the caller device 110 and the CS network is good enough without performing the handover. Therefore, the caller device 110 may keep detecting the first-link performance between the caller device 110 and the CS network continuously.

If the first-link performance is lower than the threshold T_{CH}, the caller device 110 may determine whether a PS standby call has been established in the PS network between the caller device 110 and the callee device 140. The term “standby call” in the disclosure refers to a call (e.g. on a PS network or CS network) that has been established, but that has been put on hold.

If a PS standby call has been established, the caller device 110 may determine whether the first-link performance between it and the CS network is lower than a threshold T_{CL}, wherein threshold T_{CL} is lower than threshold T_{CH}. If the first-link performance is lower than the threshold T_{CL}, the caller device 110 may terminate the voice call with the callee device 140 in the CS network, and start the PS standby call which has been established in the PS network to allow the user of the caller device 110 to keep the call with the callee device 140 through the PS network. In addition, when the caller device 110 terminates the voice call with the callee device 140 in the CS network, the callee device 140 may also start the PS standby call which has been established in the PS network to allow the user of the callee device 140 to keep the call with the caller device 110 through the PS network.

If a PS standby call has not been established, the caller device 110 may determine whether the second-link performance between it and the PS network is lower than a threshold T_{PL}. If the second-link performance is not higher than the threshold T_{PL}, it means that the link performance between the caller device 110 and the PS network is currently bad, and it is not suitable to proceed with the handover. Therefore, the caller device 110 may return to the previous process to keep detecting the first-link performance between it and the CS network. If the second-link performance is higher than the threshold T_{PL}, the caller device 110 may send a standby call invitation to the callee device 140 through the PS network.

After the callee device 140 receives the standby call invitation, the callee device 140 may determine whether the third-link performance between it and the PS network is higher than a threshold T_{PL}. If the third-link performance is not higher than the threshold T_{PL}, it means that the link performance between the callee device 140 and the PS network is currently bad, and it is not suitable to proceed with the handover. Therefore, if the third-link performance is not higher than the threshold T_{PL}, the callee device 140 may reject the standby call invitation from the caller device 110. If the third-link performance is higher than the threshold T_{PL}, the callee device 140 may accept the standby call invitation from the caller device 110. Note that, when the voice call between the caller device 110 and the callee device 140 proceeds through the CS network, the callee device 140 may start to detect the third-link performance between it and PS network. Therefore, when the callee device 140 rejects the standby call invitation from the caller device 110, the callee device 140 may continuously detect the third-link performance between it and PS network. When the callee device 140 accepts the standby call invitation from the caller device 110, the callee device 140 may stop detecting the third-link performance between it and PS network.

When the caller device 110 knows that the callee device 140 accepts the standby call invitation, the caller device 110 may establish the PS standby call with the callee device 140 through the PS network. When the caller device 110 terminates the voice call between it and the callee device 140 in the CS network, the caller device 110 and the callee device 140 may start the PS standby call which has been established in the PS network to allow users of the caller device 110 and the callee device 140 to keep the call through the PS network.

In an another embodiment of the disclosure, when the voice call between the caller device 110 and the callee device 140 proceeds through the PS network, the caller device 110 may start to detect second-link performance between it and PS network. In an embodiment of the disclosure, when the caller device 110 starts to detect the second-link performance between it and PS network, the caller device 110 may determine whether the second-link performance between it and PS network is lower than a threshold T_{PH}. If the second-link performance is higher than the threshold T_{PH}, it means that the link performance between the caller device 110 and PS network is good enough without performing the handover. Therefore, the caller device 110 may keep detecting the second-link performance between the caller device 110 and the PS network.

If the second-link performance is lower than the threshold T_{PH}, the caller device 110 may determine whether a PS standby call between it and the callee device 140 has been established in the CS network.

If a CS standby call has been established, the caller device 110 may determine whether the second-link performance between it and the PS network is lower than a threshold T_{PL}, wherein threshold T_{PL} is lower than threshold T_{PH}. If the second-link performance is lower than the threshold T_{PL}, the caller device 110 may terminate the voice call with the callee device 140 in the PS network, and start the CS standby call which has been established in the CS network to allow the user of the caller device 110 to keep the call with the callee device 140 through the CS network. In addition, when the caller device 110 terminates the voice call with the callee device 140 in the PS network, the callee device 140 may also start the CS standby call which has been established in the CS network to allow the user of the callee device 140 to keep the call with the caller device 110 through the PS network.

If the CS standby call has not been established, the caller device 110 may determine whether the first-link performance between it and the CS network is lower than a threshold T_{CL}. If the first-link performance is not higher than the threshold T_{CL}, it means that the link performance between the caller device 110 and the CS network is currently bad, and it is not suitable to proceed with the handover. Therefore, the caller device 110 may return to the previous process to keep detecting the first-link performance between it and the CS network. If the first-link performance is higher than the threshold T_{CL}, the caller device 110 may send a standby call invitation to the callee device 140 through the CS network.

After the callee device 140 receives the standby call invitation, the callee device 140 may determine whether the fourth-link performance between it and the CS network is higher than a threshold T_{CL}. If the fourth-link performance is not higher than the threshold T_{CL}, it means that the link performance between the callee device 140 and the CS network is currently bad, and it is not suitable to proceed with the handover. Therefore, if the fourth-link performance is not higher than the threshold T_{CL}, the callee device 140 may reject the standby call invitation from the caller device 110. If the fourth-link performance is higher than the threshold T_{CL}, the callee device 140 may accept the standby call invitation from the caller device 110. Note that, when the voice call between the caller device 110 and the callee device 140 proceeds through the PS network, the callee device 140 may start to detect the fourth-link performance between it and the CS network. Therefore, when the callee device 140 rejects the standby call invitation from the caller device 110, the callee device 140 may continuously detect the fourth-link performance between it and the CS network. When the callee device 140 accepts the standby call invitation from the caller device 110, the callee device 140 may stop detecting the fourth-link performance between it and the CS network.

When the caller device 110 knows that the callee device 140 accepts the standby call invitation, the caller device 110 may establish the CS standby call with the callee device 140 through the CS network. When the caller device 110 terminates the voice call between it and the callee device 140 in the PS network, the caller device 110 and the callee device 140 may start the CS standby call which has been established in the CS network to allow users of the caller device 110 and the callee device 140 to keep the call through the PS network.

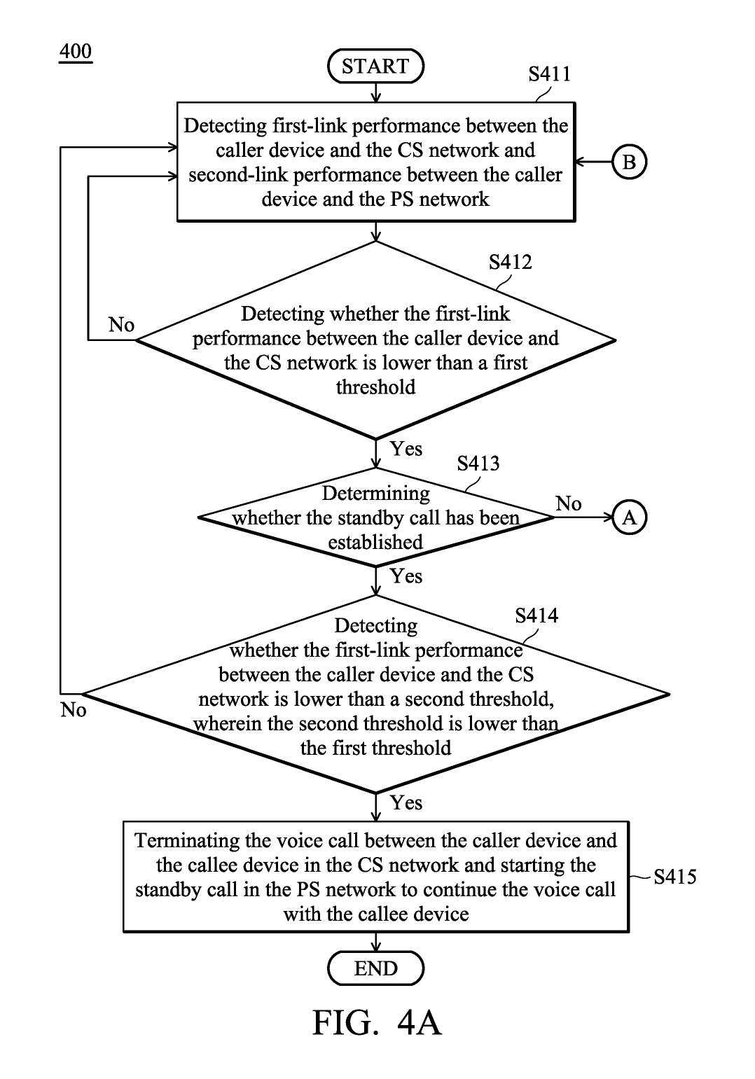

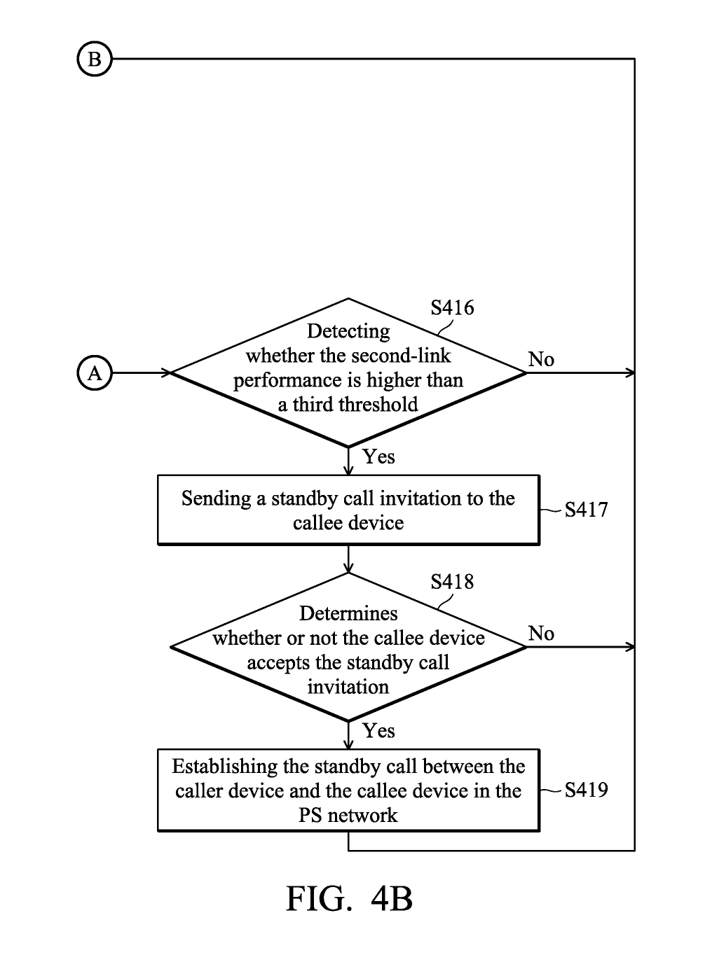

FIG. 4A-4B is a flowchart 400 illustrating a caller device handing over from the CS network to the PS network according to an embodiment of the disclosure. The method of the flowchart 400 is applied to the caller device 110 which establishes a voice call with the callee device 140 through the CS network. Furthermore, in an embodiment of the disclosure, in the method, the PS network may be a wireless network which is defined in the IEEE 802.11 standard, for instance Wi-Fi network. First, in step S411, the caller device 110 detects first-link performance between it and the CS network and the second-link performance between it and the PS network. In step S412, the caller device 110 detects whether the first-link performance between it and the CS network is lower than a first threshold (in the method, it is regarded as T_{CH}). If the first-link performance is not lower than the first threshold, the method returns to step S411, the caller device 110 may continuously detect the first-link performance between it and the CS network and the second-link performance between it and the PS network.

If the first-link performance is lower than the first threshold, step S413 is performed. In step S413, the caller device 110 may determine whether the standby call has been established. If the standby call has been established, step S414 is performed. In step S414, the caller device 110 detects whether the first-link performance between it and the CS network is lower than a second threshold (in the method, it is regarded as T_{CL}), wherein the second threshold is lower than the first threshold. If the first-link performance is lower than the second threshold, step S415 is performed. In step S415, the caller device 110 terminates the voice call between it and the callee device 140 in the CS network and starts the standby call in the PS network to continue the voice call with the callee device 140. If the first-link performance is not lower than the second threshold, the method returns to step S411, i.e. the caller device 110 may detect the first-link performance between it and the CS network and the second-link performance between it and the PS network.

If the stand-by call is not established, step S416 is performed. In step S416, the caller device 110 detects whether the second-link performance is higher than a third threshold (in the method, it is regarded as T_{PL}). If the second-link performance is not higher than the third threshold, the method returns to step S411, i.e. the caller device 110 may detect the first-link performance between it and the CS network and the second-link performance between it and the PS network.

If the second-link performance is higher than the third threshold, step S417 is performed. In step S417, the caller device 110 sends a standby call invitation to the callee device 140. In step S418, the caller device 110 determines whether or not the callee device 140 accepts the standby call invitation. If the callee device 140 accepts the standby call invitation, step S419 is performed. In step S419, the caller device 110 establishes the standby call between it and the callee device 140 in the PS network and the method returns to step S411. If the callee device 140 rejects the standby call invitation, the method returns directly to step S411.

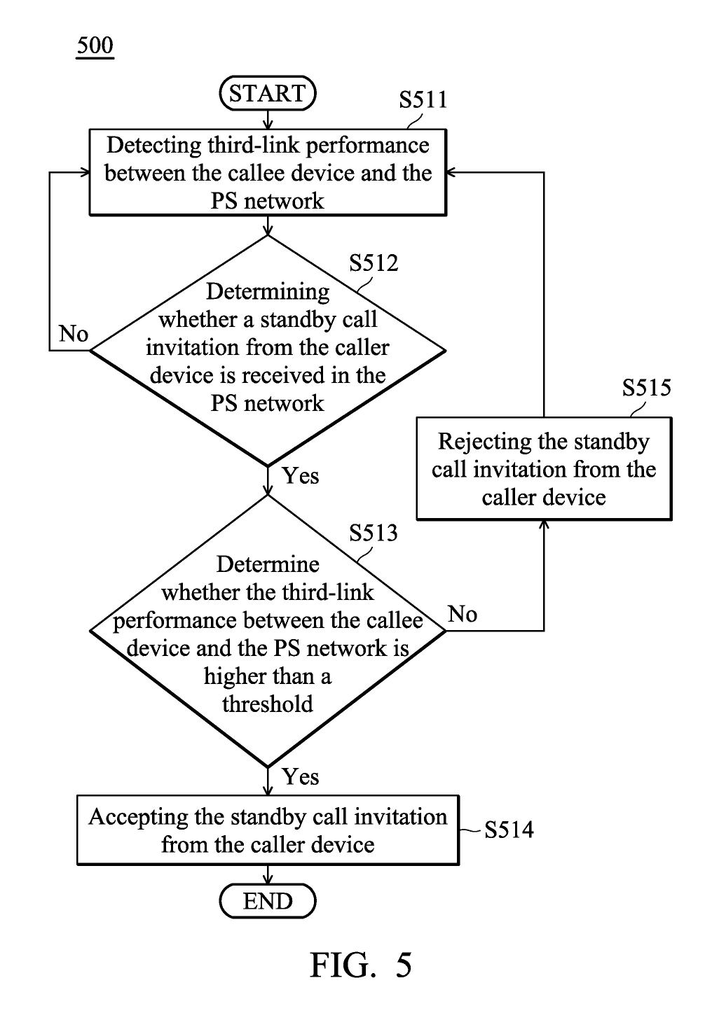

FIG. 5 is a flowchart 500 illustrating a callee device handing over from the CS network to the PS network according to an embodiment of the disclosure. The method of flowchart 500 is applied to the callee device 140 which establishes a voice call with the caller device 110 through the CS network. Furthermore, in an embodiment of the disclosure, the PS network may be a wireless network which is defined in the IEEE 802.11 standard, for instance Wi-Fi network. First, in step S511, the callee device 140 detects third-link performance between it and the PS network. In step S512, the callee device 140 determines whether a standby call invitation from the caller device 110 is received in the PS network. If the standby call invitation from the caller device 110 is not received in the PS network, steps S511 and S512 are performed again.

If the standby call invitation from the caller device 110 is received in the PS network, step S513 is performed. In step S513, the callee device 140 may determine whether the third-link performance between it and the PS network is higher than a threshold (in the method, it is regarded as T_{PL}). If the third-link performance is higher than the threshold, step S514 is performed. In step S514, the callee device 140 accepts the standby call invitation from the caller device 110 to establish the standby call with the caller device 110 in the PS network. If the third-link performance is not higher than the threshold, step S515 is performed. In step S515, the callee device 140 rejects the standby call invitation from the caller device 110, and the method returns to step S511.

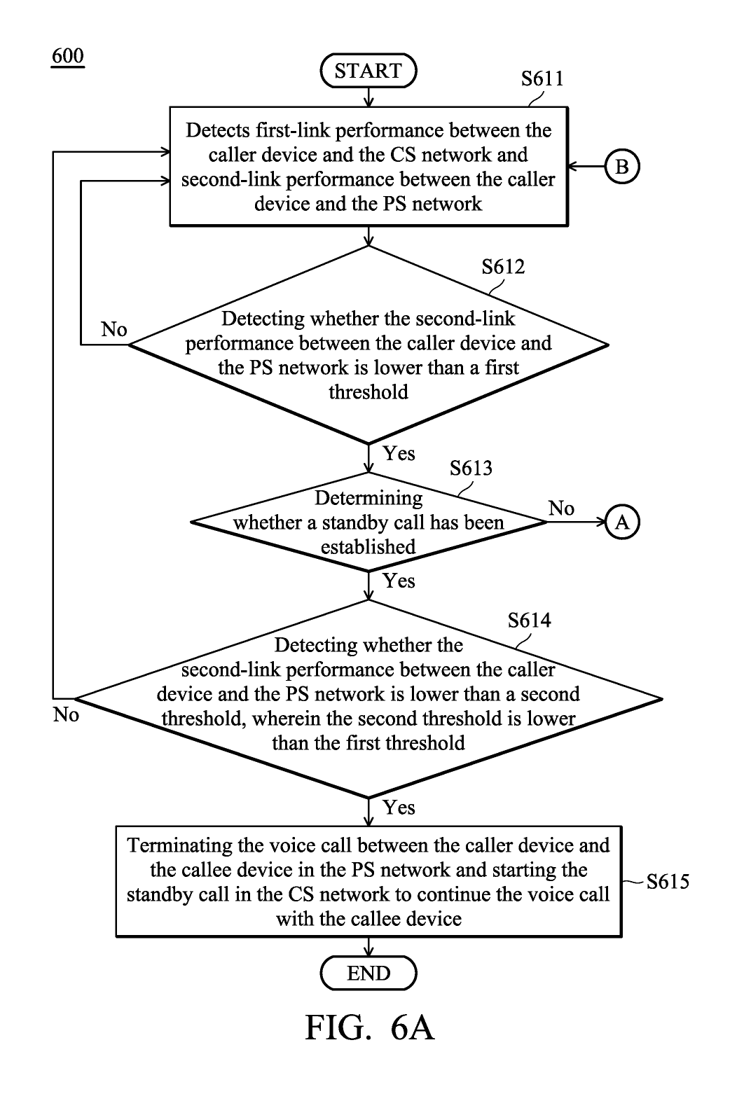

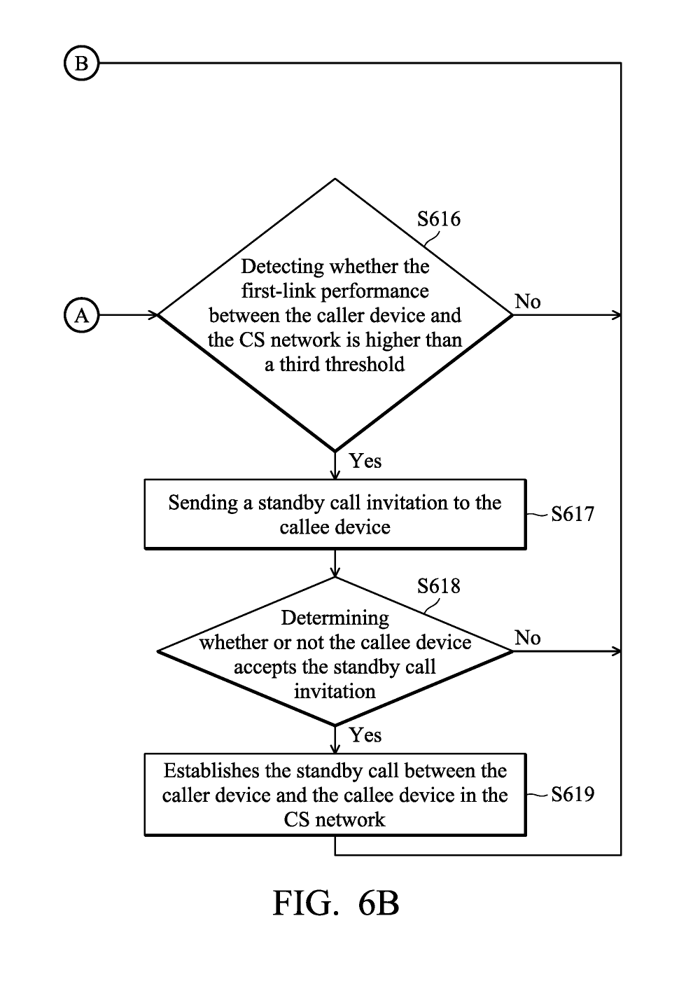

FIG. 6A-6B is a flowchart 600 illustrating a caller device handing over from the PS network to the CS network according to an embodiment of the disclosure. The method of flowchart 600 is applied to the caller device 110 which establishes a voice call with the callee device 140 through the PS network. Furthermore, in an embodiment of the disclosure, in the method, the PS network may be a wireless network which is defined in the IEEE 802.11 standard, for instance Wi-Fi network. First, in step S611, the caller device 110 detects first-link performance between it and the CS network and second-link performance between it and the PS network. In step S612, the caller device 110 detects whether the second-link performance between it and the PS network is lower than a first threshold (in the method, it is regarded as T_{PH}). If the second-link performance is not lower than the first threshold, the method returns to step S611, the caller device 110 may continuously detect the first-link performance between it and the CS network and the second-link performance between it and the PS network.

If the second-link performance is lower than the first threshold, step S613 is performed. In step S613, the caller device 110 may determine whether a standby call has been established. If a standby call has been established, step S614 is performed. In step S614, the caller device 110 detects whether the second-link performance between it and the PS network is lower than a second threshold (in the method, it is regarded as T_{PL}), wherein the second threshold is lower than the first threshold. If the second-link performance is lower than the second threshold, step S615 is performed. In step S615, the caller device 110 terminates the voice call between it and the callee device 140 in the PS network and starts the standby call in the CS network to continue the voice call with the callee device 140. If the second-link performance is not lower than the second threshold, the method returns to step S611, i.e. the caller device 110 may detect the first-link performance between it and the CS network and the second-link performance between it and the PS network.

If the stand-by call is not established, step S616 is performed. In step S616, the caller device 110 detects whether the first-link performance between it and the CS network is higher than a third threshold (in the method, it is regarded as T_{CL}). If the first-link performance is not higher than the third threshold, the method returns to step S611, i.e. the caller device 110 may detect the first-link performance between it and the CS network and the second-link performance between it and the PS network.

If the first-link performance is higher than the third threshold, step S617 is performed. In step S617, the caller device 110 sends a standby call invitation to the callee device 140. In step S618, the caller device 110 determines whether or not the callee device 140 accepts the standby call invitation. If the callee device 140 accepts the standby call invitation, step S619 is performed. In step S619, the caller device 110 establishes the standby call between it and the callee device 140 in the CS network and the method returns to step S411. If the callee device 140 rejects the standby call invitation, the method returns directly to step S411.

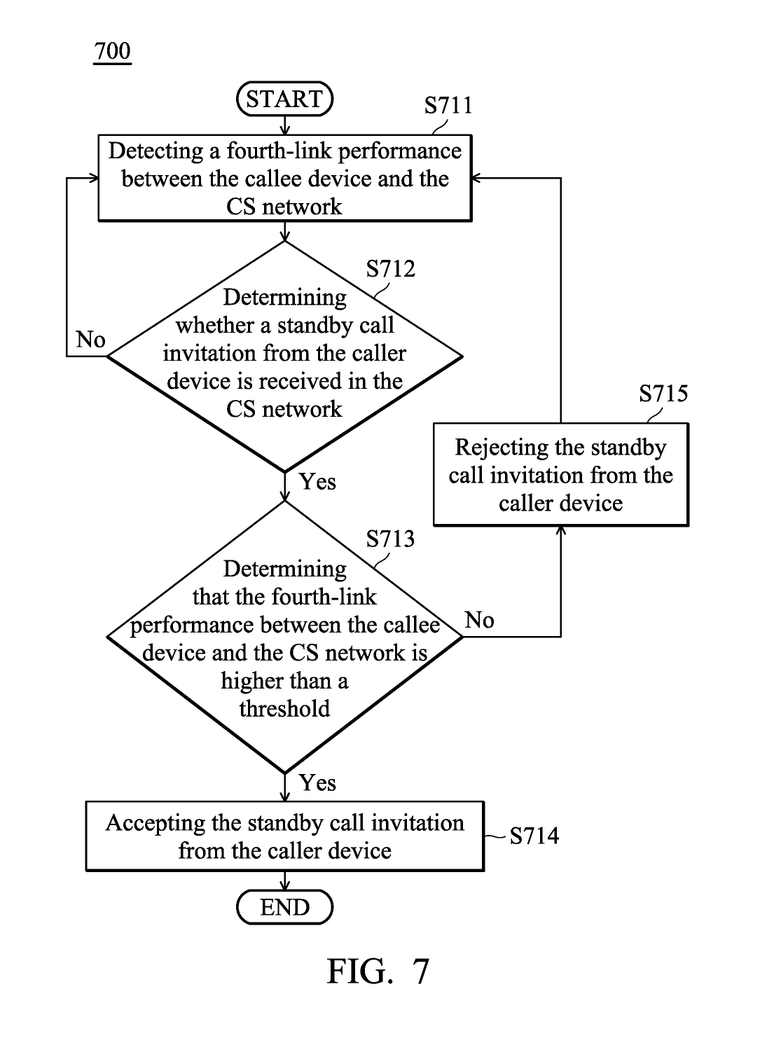

FIG. 7 is a flowchart 700 illustrating a callee device handing over from the PS network to the CS network according to an embodiment of the disclosure. The method of flowchart 700 is applied to the callee device 140 which establishes a voice call with the caller device 110 through the PS network. Furthermore, in an embodiment of the disclosure, the PS network may be a wireless network which is defined in the IEEE 802.11 standard, for instance Wi-Fi network. First, in step S711, the callee device 140 detects a fourth-link performance between it and the CS network. In step S712, the callee device 140 determines whether a standby call invitation from the caller device 110 is received in the CS network. If a standby call invitation from the caller device 110 is not received in the CS network, steps S711 and S712 are performed again.

If a standby call invitation from the caller device 110 is received in the CS network, step S713 is performed. In step S713, the callee device 140 may determine that the fourth-link performance between it and the CS network is higher than a threshold (in the method, it is regarded as T_{CL}). If the fourth-link performance is higher than the threshold, step S714 is performed. In step S714, the callee device 140 accepts the standby call invitation from the caller device 110 to establish the standby call with the caller device 110 in the CS network. If the fourth-link performance is not higher than the threshold, step S715 is performed. In step S715, the callee device 140 rejects the standby call invitation from the caller device 110, and the method returns to step S711.

According to the handover methods of the disclosure, when the user moves inside (e.g. a basement) or to certain other locations where reception is bad, the user may establish the VoIP call with other user through the wireless network (e.g. Wi-Fi network) to maintain the call which will be dropped. When the user moves from inside (e.g. a basement) or certain other locations where reception to outside, and the connection with the wireless will be end, the user equipment of the user will hand over to the telecommunication network to maintain the call which will be dropped. Thus, the handover methods of the disclosure provide the better call performance to the user.

Use of ordinal terms such as “first”, “second”, “third”, etc., in the disclosure and claims is for description. It does not by itself connote any order relationship.

The method and algorithm disclosed herein may be executed directly by at least one processor which is configured to the call processing device to apply in hardware, in a software module or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor could read information (e.g., code) from the storage medium and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some embodiments any suitable computer-program product may include a computer-readable medium comprising codes relating to one or more of the embodiments of the disclosure. In some embodiments a computer program product may include packaging materials.

The above paragraphs describe many aspects. Accordingly, the teaching of the disclosure may be accomplished by many methods, and any configurations or functions in the disclosed embodiments only present a representative condition. Those who are skilled in this technology can understand that all of the disclosed aspects in the disclosure may be applied independently or be incorporated.

While the disclosure has been described by way of example and as exemplary embodiments only, it should be understood that the disclosure is not configured to limit thereto. Those who are skilled in this technology can still make various alterations and modifications without departing from the scope and spirit of this disclosure. Therefore, the scope of the invention shall be defined and protected by the following claims and their equivalents.

What is claimed is:

1. A handover method, comprising:
establishing a voice call between a caller device and a callee device in a first network;
detecting first-link performance between the caller device and the first network and detecting second-link performance between the caller device and a second network;
detecting third-link performance between the callee device and the second network; and
determining whether to turn over from the first network to the second network and start a standby call between the caller device and the callee device which has been established in the second network, according to the first-link performance, the second-link performance and the third-link performance,
wherein the first network and the second network are respectively a circuit-switched network and a packet-switched network or respectively a packet-switched network and a circuit-switched network.

2. The handover method of claim 1, further comprising:
detecting whether the first-link performance between the caller device and the first network is lower than a first threshold; and
determining whether the standby call has been established if the first-link performance is lower than the first threshold.

3. The handover method of claim 2, further comprising:
detecting whether the first-link performance between the caller device and the first network is lower than a second threshold if the standby call has been established, wherein the second threshold is lower than the second threshold; and
terminating the voice call and starting the standby call if the first-link performance is lower than the second threshold.

4. The handover method of claim 2, further comprising:
detecting whether the second-link performance between the caller device and the second network is higher than a third threshold if the standby call has not been established; and
sending a standby call invitation to the callee device from the caller device if the second-link performance is higher than the third threshold.

5. The handover method of claim 4, further comprising:
determining whether the third-link performance between the callee device and the second network is higher than the third threshold when the callee device receives the standby call invitation;
accepting the standby call invitation if the third-link performance is higher than the third threshold; and
establishing the standby call.

6. The handover method of claim 5, further comprising:
rejecting the standby call invitation if the third-link performance is lower than the third threshold.

7. The handover method of claim 4, further comprising:
establishing the standby call between the caller device and the callee device in the second network when the callee device accepts the standby call invitation.

8. The handover method of claim 1, further comprising:
detecting the first-link performance, the second-link performance and the third-link performance according to signal strength.

9. A user equipment, applied as a caller device, and the user equipment comprising:
a radio communication device, configured to establish a voice call with a callee device through a first network; and
a call processing device, configured to detect a first-link performance between the caller device and the first network and detect a second-link performance between the caller device and a second network, and according to the first-link performance and the second-link performance determine whether to turn over from the first network to the second network, and start a standby call between the caller device and the callee device which has been established in the second network,
wherein the first network and the second network are respectively a circuit-switched network and a packet-switched network or respectively a packet-switched network and a circuit-switched network.

10. The user equipment of claim 9, wherein the call processing device is further configured to detect whether the first-link performance between the caller device and the first network is lower than a first threshold and if the first-link performance is lower than the first threshold, the call processing device is further configured to determine whether the standby call has been established.

11. The user equipment of claim 10, wherein if the standby call has been established, the call processing device is further configured to detect whether the first-link performance between the caller device and the first network is lower than a second threshold wherein the second threshold is lower than the second threshold, and if the first-link performance is lower than the second threshold, the call processing device further terminates the voice call and starts the standby call.

12. The user equipment of claim 10, wherein if the standby call has not been established, the call processing device is further configured to detect whether the second-link performance between the caller device and the second network is higher than a third threshold, and if the second-link performance is higher than the third threshold, the call processing device further sends a standby call invitation from the caller device to the callee device through the radio communication device.

13. The user equipment of claim 12, wherein when the callee device accepts the standby call invitation, the call processing device establishes the standby call between the caller device and the callee device in the second network through the radio communication device.

14. The user equipment of claim 12, wherein the call processing device detects the first-link performance and the second-link performance according to signal strength.

15. A user equipment, applied as a callee device, and the user equipment comprising:
a radio communication device, configured to establish a voice call with a caller device through a first network; and
a call processing device, configured to detect a third-link performance between the callee device and a second network, and according to the third-link performance determine whether to accept a standby call invitation from the caller device, and when a handover from the first network to the second network is performed, start a standby call with the caller device which has been established in the second network,
wherein the first network and the second network are respectively a circuit-switched network and a packet-switched network or respectively a packet-switched network and a circuit-switched network.

16. The user equipment of claim 15, wherein when the callee device receives the standby call invitation, the call processing device is further configured to determine whether the third-link performance between the callee device and the second network is larger than a third threshold, and if the third-link performance is larger than the third threshold, the call processing device accepts the standby call invitation and establishes the standby call.

17. The user equipment of claim 16, wherein if the third-link performance is lower than the third threshold, the call processing device rejects the standby call invitation.

18. The user equipment of claim 15, wherein the call processing device detects the third-link performance according to signal strength.

19. A handover system, comprising:
a first network;
a second network;
a callee device, configured to detect a third-link performance between the callee device and the second network; and
a caller device, establishing a voice call between the caller device and the callee device in the first network, configured to detect a first-link performance between the caller device and the first network and a second-link performance between the caller device and the second network, and according to the first-link performance, and the second-link performance determine whether to turn over from the first network to the second network and start a standby call between the caller device and the callee device which has been established in the second network,
wherein the first network and the second network are respectively a circuit-switched network and a packet-switched network or respectively a packet-switched network and a circuit-switched network.

20. The handover system of claim 19, wherein the caller device is further configured to detect whether the first-link performance between the caller device and the first network is lower than a first threshold, and if the first-link performance is lower than the first threshold, the caller device further determines whether the standby call has been established.

21. The handover system of claim 20, wherein if the standby call has been established, the caller device is further configured to detect whether the first-link performance between the caller device and the first network is lower than a second threshold, wherein the second threshold is lower than the second threshold, and if the first-link performance is lower than the second threshold, the caller device terminates the voice call and starts the standby call.

22. The handover system of claim 20, wherein if the standby call has not been established, the caller device is further configured to detect whether the second-link performance between the caller device and the second network is higher than a third threshold, and if the second-link performance is higher than the third threshold, the caller device sends a standby call invitation to the callee device from the caller device.

23. The handover system of claim 22, wherein when the callee device receives the standby call invitation, the callee device is configured to determine whether the third-link performance between the callee device and the second network is higher than the third threshold, and if the third-link performance is higher than the third threshold, the callee device accepts the standby call invitation to establish the standby call.

24. The handover system of claim 23, wherein if the third-link performance is lower than the third threshold, the callee device rejects the standby call invitation.

25. The handover system of claim 22, wherein when the callee device accepts the standby call invitation, the caller device establishes the standby call between the caller device and the callee device in the second network.

26. The handover system of claim 19, wherein the caller device detects the first-link performance and the second-link performance according to signal strength and the callee device detects the third-link performance according to the signal strength.
